(19) United States
(12) Patent Application Publication
(10) Pub. No.: US 2006/0162126 A1
(43) Pub. Date: Jul. 27, 2006

(54) Device for fastening door handles

(76) Inventor: Ralf Kreyenborg, Bad Salzuflen (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/527,130

(22) PCT Filed: Aug. 17, 2004
(86) PCT No.: PCT/EP04/09187

§ 371 Date: Mar. 8, 2005

(30) Foreign Application Priority Data
Sep. 1, 2003 (DE) 103 40 562.3

(51) Int. Cl. E05B 1/00

(52) U.S. Cl. 16/412

(57) ABSTRACT

A pair of identically constructed door handles each have a pocket hole which can be axially aligned with a hole in a door leaf, and a threaded transverse bore which intersects the pocket hole. A pin has a middle portion which is received in the hole in the leaf, and first and second end portions which are received in respective pocket holes, the first end portion having a circumferential groove, the second end portion having a plurality of blind holes which are offset axially and circumferentially. First and second setscrews are received in respective transverse bores, the first setscrew engaging the circumferential groove in the first end portion, the second setscrew engaging one of the blind holes in the second end portion.

The invention is directed to a device for fastening door handles which are arranged opposite one another on both sides of a door leaf and which each have a pocket hole for receiving a pin whose middle portion penetrates the door leaf and whose end portions can be locked in the oppositely-located pocket holes. A circumferential groove is provided at a first end portion of the pin and a threaded screw which penetrates a transverse bore hole in the door handle can be adjusted against this circumferential groove.

In door handles of the generic type mentioned above, not only is there a demand for an optically attractive design, but economical manufacture and multipurpose use are also required, i.e., particularly the ability to use a fitting comprising two oppositely located door handles in door leaves of different thickness. With respect to glass doors, for example, the commercially available glass doors that are used have a glass thickness of 8 to 12 mm.

The generic AT-PS 336 435 shows a possibility for adapting to different thicknesses of a door leaf. In the previously known device, one of the two oppositely located door handles has a pocket hole with an internal thread into which an end portion of a pin can be screwed to a desired depth, while the other door handle holds the second end portion of the pin with a pocket hole and can be secured to the pin by a threaded screw which penetrates a transverse bore hole of the door handle and engages in a circumferential groove of the pin. It is possible through the selection of the screw-in depth of the pin to adapt to different thicknesses of a door leaf. However, the arrangement of an internal thread in one of the two door handles is compulsory, i.e., every fitting comprising two door handles requires two different door handles which are not interchangeable. The production of the internal thread and the necessary manufacture of differently formed door handles makes the fitting expensive.

A similar device is disclosed in GB-PS 1 155 333, in which an end portion of a pin likewise engages in a pocket hole of a door handle by means of a screw thread, while a trough-shaped recess which extends in direction of the longitudinal axis of the pin and in which a threaded screw penetrating the transverse bore hole of the door handle engages is arranged in the other end portion. In this case, again, a fitting requires that two differently formed door handles.

Further, AT 003 665 U1 discloses the fastening of oppositely located door handles to door leaves of different thickness in which pairs of countersinks are distributed over the circumference of the corresponding pin so as to be offset by about 120° relative to one another. Accordingly, by rotating the pin it is possible to adjust the fitting to the thickness of the door leaf.

It is the object of the invention to optimize the manufacture of door handles, particularly of so-called push handles, while taking into account the possibility of adapting to different thicknesses of a door leaf, particularly of glass doors, and preserving an attractive visual form.

The above-stated object is met by the invention through the teaching of claim 1.

According to the invention, the means required for adapting to different thicknesses of a door leaf are not components of the door handle, but rather of the pin, i.e., the oppositely located door handles of a fitting can advantageously be identically constructed, while rotating the pin around its longitudinal axis makes it possible to adapt to different thicknesses of a door leaf. In the present case, the maximum adjustment is several millimeters, which is generally considered adequate for glass doors. When a more extensive adjustment is required, it is sufficient merely to exchange the pin for a pin with correspondingly offset drill holes while retaining the same door handles. Accordingly, the invention makes it possible to adapt to door leaves of different thickness in a technically advantageous manner without the need for different constructions of the two oppositely located door handles forming a component of the fitting. This results in economical manufacture and inventory. The door handles themselves advantageously comprise special steel, but can be manufactured from any material in principle.

Further advantageous developments of the invention are the subject matter of the dependent claims.

When used in glass doors, it has proven sufficient to provide a plurality of drill holes in the pin, preferably three drill holes which are arranged so as to be offset by about 120° in circumferential direction. The offset of adjacent drill holes in direction of the longitudinal axis of the pin is a fixed amount determined by the thickness of the different panes of glass. These offsets can be jumps of 2 mm, for example. This results in a maximum adjusting range of several millimeters. The adjusting jump of fixed amount does not impair the fixed contact of the door handle at the door leaf because the door handle can be cushioned easily by flexible means arranged between the door handle and the door leaf when using glass doors, e.g., by means of a corresponding glass protector.

In a further development of the invention, it has proven advantageous, particularly with door handles constructed as push handles, that the push handle comprises a handle extending parallel to the door leaf and a brace which extends orthogonal to the handle, is directed against the door leaf and has a pocket hole, wherein the transverse bore holes are arranged in a diametral enlargement of the brace that is arranged in the area of contact at the door leaf. Due to the material amassed in the contact area, for example, of a pane of glass, the above-mentioned embodiment form ensures that the contact surface of the door handle at the pane of glass is larger than the diameter of the brace and ensures a sufficient screw-in depth for the threaded screws. The screw-in depth is so dimensioned that the screwed in, i.e., tightened, threaded screw in a visually advantageous manner does not project over the diametral enlargement. Further, an advantageous covering of the glass protector is ensured in a manner to be described in the following, e.g., in glass doors.

In a further development of the invention, the handle and the brace are constructed in one piece.

The invention will be described more fully in the following with reference to an embodiment example.

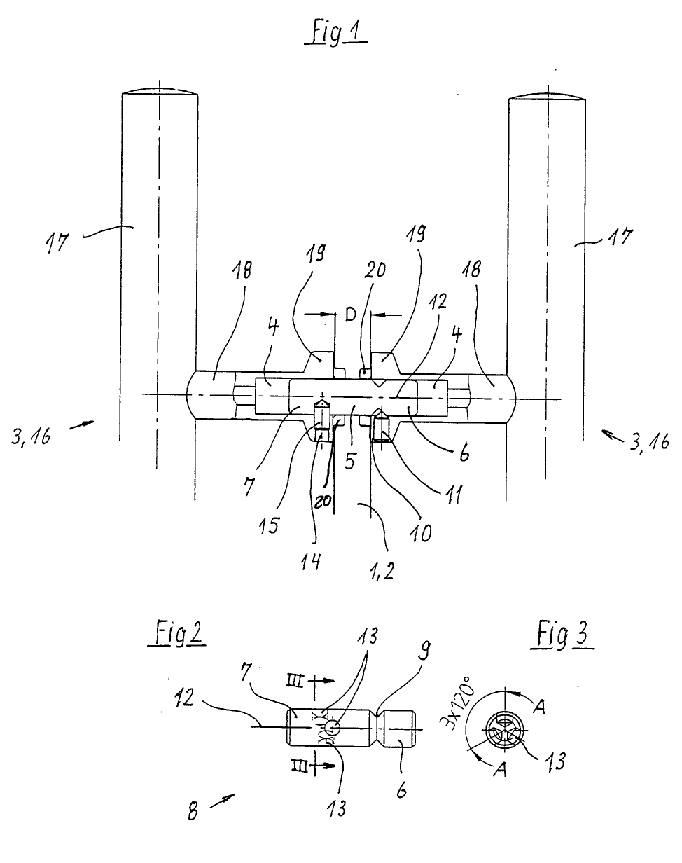

FIG. 1 shows a view of a door handle arranged on both sides of a door leaf;

FIG. 2 shows the pin by itself;

FIG. 3 shows a section III-III according to FIG. 2.

As is shown in FIG. 1, two door handles 3 which are identically constructed push handles 16 in the embodiment example are arranged on both sides of a door leaf 1 formed as a glass pane 2. Each push handle 16 comprises a handle 17 and a brace 18 formed integral therewith. The braces 18 each have a pocket bore 4 in which a pin 8 is inserted so as to penetrate the glass pane 2 by its middle portion 5. The thickness of the glass pane 2 is designated by D in the present case.

As can be seen particularly from FIG. 2, the pin 8 has a first end portion 6 and a second end portion 7. A circumferential groove 9 is provided in the area of the end portion 6, while three drill holes 13 are arranged in end portion 7 so as to be offset, respectively, by 120° in circumferential direction A (see FIG. 3). As is further shown in FIG. 2, the drill holes 13 are offset relative to one another in direction of the longitudinal axis 12 of the pin 8 in addition.

According to FIG. 1, the braces 18 have diametral enlargements 19 in the area of contact with the glass pane 2. Transverse bore holes 10 and 14 which receive threaded screws 11 and 15 are introduced in these diametral enlargements 19. It can be seen that the threaded screw 11 engages in the circumferential groove 9, while the threaded screw 15 can be screwed into one of the drill holes 13 so as to adapt to different thicknesses D of the glass pane 2. In the present case, a flexible glass protector 20 is embedded in the glass pane 2 on both sides, which ensures a reliable contact of the braces 18 at the glass pane 2.

### REFERENCE NUMBERS

1 door leaf
2 glass pane
3 door handle
4 pocket hole
5 middle portion
6 end portion
7 end portion
8 pin
9 circumferential groove
10 transverse bore hole
11 threaded screw
12 longitudinal axis
13 drill holes
14 transverse bore hole
15 threaded screw
16 push handle
17 handle
18 brace
19 diametral enlargement
20 glass protector
A arrow direction
D thickness

1-6. (canceled)

7. A door handle assembly for fitting to a door leaf provided with a hole, said assembly comprising:
a pair of identically constructed door handles, each handle having a pocket hole which can be axially aligned with the hole in the leaf, and a threaded transverse bore which intersects the pocket hole;
a pin having a middle portion which is received in the hole in the leaf, and first and second end portions which are received in respective said pocket holes, said first end portion having a circumferential groove, said second end portion having a plurality of blind holes which are offset axially and circumferentially; and
first and second setscrews received in respective said transverse bores, said first setscrew engaging said circumferential groove in said first end portion, said second setscrew engaging one of said blind holes in said second end portion.

8. The assembly of claim 7 wherein the blind holes number three and are offset circumferentially by 120 degrees.

9. The assembly of claim 7 wherein the blind holes are axially offset from each other by a uniform amount.

10. The assembly of claim 7 wherein each door handle comprises a transverse portion which is mounted parallel to the door leaf, and a brace which extends perpendicular to the transverse portion, said pocket holes being provided in said braces.

11. The assembly of claim 10 wherein each said brace has a diametric enlargement proximate to said door leaf, each said transverse bore being provided in a respective said diametric enlargement.

12. The assembly of claim 10 wherein the transverse portion and the brace are formed as one piece.
